(19) United States
(12) Patent Application Publication
(10) Pub. No.: US 2015/0371724 A1
(43) Pub. Date: Dec. 24, 2015

(54) INTEGRATED-TYPE PRESSURIZED WATER NUCLEAR REACTOR COMPRISING AN INTEGRATED PRESSURIZER

(71) Applicant: SOCIETE TECHNIQUE POUR L'ENERGIE ATOMIQUE TECHNICATOME, Villiers Le Bacle (FR)

(72) Inventors: Laurent CANDILLIER, SIMIANE-COLLONGUE (FR); Jean-Yves CHARCOSSET, VENELLES (FR); Philippe PARRAUD, BARJOLS (FR)

(21) Appl. No.: 14/763,400

(22) PCT Filed: Jan. 21, 2014
(86) PCT No.: PCT/EP2014/051086

§ 371 Date: Jul. 24, 2015

(30) Foreign Application Priority Data
Jan. 25, 2013 (FR) 1350672

(51) Int. Cl. G21C 1/08; G21C 13/067; G21C 1/09

(52) U.S. Cl. CPC G21C 1/086; G21C 1/09; G21C 13/067

(57) ABSTRACT

A pressurized water nuclear reactor includes a primary shell formed by a vessel integrating a core of the nuclear reactor and a cover; a pressurizer built into the shell including hydraulic lines connected to external circuits, the cover of the shell forming an upper wall of the pressurizer, wherein at least one hydraulic line of the pressurizer is formed by: a first line arranged through the vessel of the primary shell and under a plane for positioning the cover onto the vessel, and a second line secured to the cover; the first line and the second line being suitable for sealingly and detachably fitting into one another when the cover is positioned onto the vessel, and a resilient system ensuring the contact between ends of the first and second lines.

The present invention relates to the field of pressurized water nuclear reactors and more particularly pertains to the pressurization of the primary liquid.

Pressurized water nuclear reactors comprise a primary circuit in which the cooling water, called primary water, of the reactor is maintained at a high pressure, of the order of 155 bars, by means of a pressurizer.

The pressurizer makes it possible to maintain the pressure in the primary circuit between certain determined limits, either by sprinkling when the pressure has a tendency to overrun the acceptable upper limit, or by electrical heating of the primary water when the pressure has a tendency to drop below the acceptable lower value.

In integrated-type, or instead compact-type, pressurized water reactors, the pressurizer is integrated directly in the reactor vessel, and more precisely in the upper part of the reactor vessel, so as to make the installations more compact and to reduce the risks of rupture of confinement of the primary circuit.

During nuclear fuel loading/unloading operations and in order to have access to the boiler unit, the cover of the reactor vessel is removed and all the lead-throughs that are attached thereto and which as a result traverse the pressurizer are also removed.

The integration of a pressurizer in the upper part of the reactor vessel requires facilitating the demountability of the cover, which is obtained by reducing the number of operations to be carried out so as to reduce the down time of the reactor, the exposure of intervening personnel and consequently the economic cost of maintenance operations.

Finally, after reloading, each of the reconstituted connections need to be subject to numerous and meticulous operations such as the control of the state of the joints, seal bearings, the control or the replacement of the nuts and bolts, the tightening of the nuts and bolts to the predefined torque, the making of welds of sealing lips if needs be. Once assembled, the connections have to be subject to precise control in order to check the correct connection, which may result in: a dye penetrant test of the sealing welds, a hydraulic test.

In this context, the present invention proposes providing an integrated-type or compact-type pressurized water nuclear reactor, comprising a pressurizer built into the upper part of the vessel making it possible to reduce the number of connections exterior to the vessel and traversing the pressurizer so as to simplify the assembly/dismantling operations during reloading with fuel.

To this end, the invention proposes a pressurized water nuclear reactor comprising:
a shell formed by a vessel integrating the core of the nuclear reactor and a cover;
a pressurizer built into said shell comprising hydraulic lines connected to external circuits, said cover of the shell forming the upper wall of said pressurizer;

said nuclear reactor being characterized in that at least one hydraulic line is formed by:
a first line arranged through said vessel of the primary shell and under the plane for positioning the cover onto said vessel;
a second line secured to said cover;

said first line and said second line being suitable for sealingly and detachably fitting into one another when said cover is positioned onto said vessel, resilient means ensuring the contact between the ends of the two lines.

Thanks to the invention, the two parts of a same line do not need to be demountable to assure the dismantling of the cover. The continuity of the line takes place inside the pressurized shell and the relative sealing of each hydraulic line is realized during the positioning of the cover of the reactor through the placing in contact of the two lines, constituting the hydraulic connection, which are arranged opposite each other.

It will nevertheless be noted that absolute sealing is not required and that the pressure differences exerted on the detachable connection are linked to the loss of head of the flows in the lines.

Thus thanks to the invention, the operations of positioning and removing the cover are simplified by the reduction of the number of connections traversing the cover.

Advantageously, the reactor comprises a plurality of hydraulic lines according to the invention.

Obviously, this type of junction in two parts may be multiplied as often as necessary on the through lines to assure the correct operation of the pressurizer.

The nuclear reactor according to the invention may also have one or more of the characteristics below, considered individually or according to all technically possible combinations thereof:
said resilient means are arranged on a vertical portion of said first line of the hydraulic line;
said resilient means are formed by a metal bellows;
said end of said first line has an end piece of spherical shape;
said end of said first line has an end piece of conical shape;
said pressurizer built into said primary shell comprises a refrigeration line, a condensation line, a discharge line, a water supply line, said refrigeration line and/or said condensation line and/or said discharge line and/or said water supply line is realized by:
a first line arranged through said vessel of the primary shell and under the plane for positioning the cover onto said vessel;
a second line secured to said cover;
said first line and said second line being suitable for sealingly and detachably fitting into one another when said cover is positioned onto said vessel, resilient means ensuring the contact between the ends of the two lines.

Advantageously, said first line arranged through said vessel of the primary shell and under the plane for positioning the cover onto said vessel is a line having a longitudinal, horizontal, oblique or vertical axis.

Other characteristics and advantages of the invention will become clear from the description that is given thereof below, by way of indication and in no way limiting:

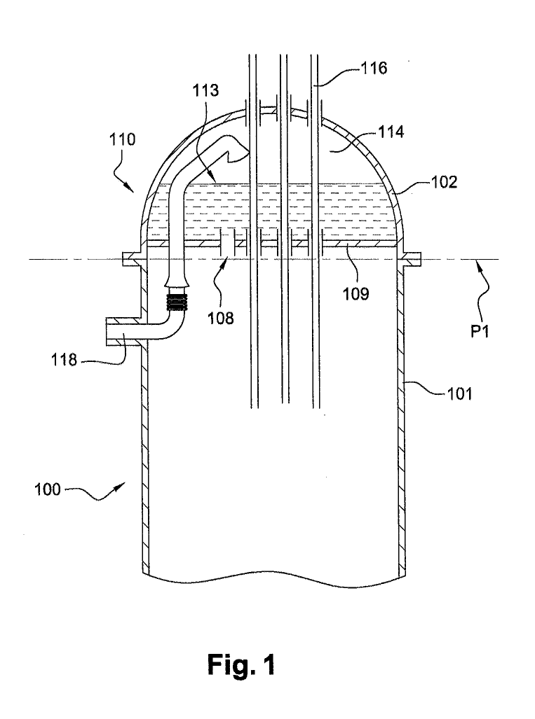

FIG. 1 schematically represents a view of the upper part of a nuclear reactor according to the invention integrating a pressurizer in the upper part of the primary shell;

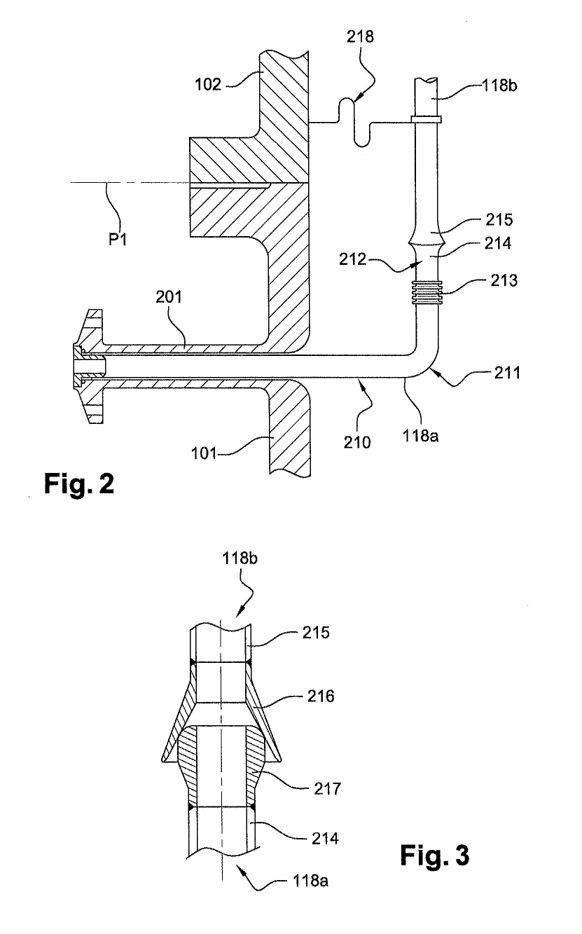

FIG. 2 schematically represents the arrangement of a hydraulic line of the pressurizer;

FIG. 3 represents the demountable connection of the hydraulic line illustrated in FIG. 2.

FIG. 1 thus schematically represents an integrated-type or compact-type nuclear reactor 100 having:
a primary shell 100 formed by a vessel 101 integrating the core of the nuclear reactor and a cover 102 covering the core of the reactor and closing the vessel 101;
a pressurizer 110 built into the upper part of the primary shell 100, the cover 102 of the primary shell forming the upper dome of the pressurizer 110;
demountable internal lines assuring the communication between the vessel 101 and the pressurizer 110;
hydraulic lines 118 for connecting between circuits external to the vessel 101 and the pressurizer 110.

The pressurizer 110 is delimited in the lower part by a lower wall 109 thereby forming a physical separation between the pressurizer 110 and the core of the reactor (not represented) situated in the lower part of the vessel 101.

The inner space of the pressurizer 110 (formed by the part of the primary shell 100 situated above the lower plate 109 is in communication with the primary liquid via orifices 108). Thus, the pressurizer 110 is permanently partially filled with primary water. The primary water 113 level inside the pressurizer 110 is a function of the current pressure of the primary water of the reactor. The roof 114 of the pressurizer 110 is filled with steam, at a pressure substantially equal to the pressure of the primary water present in the pressurizer 110.

The lower wall 109 also has openings enabling the passage of the control rods 116 of control clusters and the instrumentation necessary for the operation of the nuclear reactor.

FIG. 2 illustrates in a more detailed manner an example of embodiment of a particular hydraulic line 118, such as for example a primary water condensation line able to be connected to a circuit external to the vessel 101.

The hydraulic line 118 is formed by two separate parts:
a first lower part 118a arranged through the wall of the vessel 101 and positioned under the plane P1 for position the cover 102;
a second upper part 118b secured to the cover 102.

FIG. 3 illustrates precisely the junction between the two parts 118a and 118b of the hydraulic line 118.

The first lower part 118a of the hydraulic line 118 traverses the vessel 101 at the level of a boss 201 provided for this purpose at the level of the wall of the vessel 101. The end of the hydraulic line 118 situated outside of the primary shell 100 is connected to a primary water supply pipe 30 via means provided for this purpose.

The first lower part 118a is formed by a substantially horizontal section 210, an angled section 211 and a vertical section 212. Resilient means 213 are fitted onto the vertical section 212 so as to enable a certain movement of the end 214 of the vertical section 212. In the embodiment illustrated in FIG. 2, the resilient means 213 are formed by a bellows able to relax or to contract.

The second upper part 118b of the hydraulic line 118 comprises at least one vertical section, the lower end of which is suitable for assuring a sealed and detachable connection with the lower part 118a. The second upper part 118b is secured to the cover 102 via a support 218.

The end 215 of the upper part 118b is terminated by an end piece of substantially conical shape 216, as illustrated in a precise manner in FIG. 3, secured to the end 215 for example by welding. The conical end piece 216 is able to cooperate with an end piece of spherical shape 217 secured onto the end 214 of the lower part 118a, for example by welding.

The two end pieces 216 and 217 thus form a sealed connection realized by a sphere/cone contact. The sealed contact is assured by the resilient means 213 which allows a certain elasticity of the end 214 to the coupling of the two end pieces 216 and 217.

Thus during nuclear fuel loading/unloading operations, the dismantling of the cover 102 causes the disconnection of the hydraulic line 118, the upper part 118b of the line being advantageously secured to the cover 102. During the mounting of the cover 102, the upper part 118b of the hydraulic line 118 fits into the lower part 118a via the sphere/cone end pieces.

The pre-positioning of the cover 102 while it is being lowered is assured via means provided for this purpose.

Obviously, the invention is not limited to the embodiment that has been described.

To resume, the solution proposed is based on the principle of the simplification of the operations of positioning and removing the cover by the reduction in the number of connections to dismantle then to control as well as the limitation or even the elimination of the fluid connections traversing the cover of the primary shell.

Consequently, the solution proposed applies just as well to hydraulic connection lines between circuits external to the vessel and the pressurizer as to demountable internal lines assuring the fluidic communication between the vessel and the pressurizer.

The principle of the sealed connection by sphere/cone contact and detachability of the fluid connections of the pressurizer is applicable to all the fluid lines of the pressurizer, such as the refrigeration line, the condensation line, a discharge line, a water supply line.

1. A pressurized water nuclear reactor comprising:
a primary, shell formed by a vessel integrating a core of the nuclear reactor and a cover;
a pressurizer built into said primary shell comprising hydraulic lines connected to external circuits, said cover of the primary shell forming an upper wall of said pressurizer;
wherein at least one hydraulic line of said pressurizer is formed by:
a first line arranged through said vessel of the primary shell and under a plane for positioning the cover onto said vessel, and
a second line secured to said cover;
said first line and said second line being suitable for sealingly and detachably fitting into one another when said cover is positioned onto said vessel, and
resilient means ensuring the contact between ends of the first and second lines.

2. The pressurized water nuclear reactor according to claim 1, wherein said resilient means are arranged on a vertical portion of said first line of the at least one hydraulic line.

3. The pressurized water nuclear reactor according to claim 1, wherein said resilient means are formed by a metal bellows.

4. The pressurized water nuclear reactor according to claim 1, wherein the end of said first line has an end piece of spherical shape.

5. The pressurized water nuclear reactor according to claim 1, wherein the end of said first line has an end piece of conical shape.

6. The pressurized water nuclear reactor according to claim 1, wherein said pressurizer integrated in said primary shell comprises a refrigeration line, a condensation line, a discharge line, a water supply line, and wherein said refrigeration line and/or said condensation line and/or said discharge line and/or said water supply line is formed by:
the first line arranged through said vessel of the primary shell and under the plane for positioning the cover onto said vessel;
the second line secured to said cover;
said first line and said second line being suitable for sealingly and detachably fitting into one another when said cover is positioned onto said vessel, the resilient means ensuring the contact between the ends of the first and second lines.
